(19) United States
(12) Patent Application Publication
(10) Pub. No.: US 2025/0309979 A1
(43) Pub. Date: Oct. 2, 2025

(54) CELLULAR MESH NETWORK FOR REMOTE RADIO UNITS

(71) Applicant: Outdoor Wireless Networks LLC, Richardson, TX (US)

(72) Inventors: Rajesh Kaliaperumal, San Jose, CA (US); Milind Kulkarni, Hawthorn Woods, IL (US)

(73) Assignee: Outdoor Wireless Networks LLC, Richardson, TX (US)

(21) Appl. No.: 18/873,238

(22) PCT Filed: Jun. 6, 2023
(86) PCT No.: PCT/US2023/024579

§ 371 Date: Dec. 9, 2024

Related U.S. Application Data
(60) Provisional application No. 63/350,816, filed on Jun. 9, 2022.

(51) Int. Cl. H04B 7/26; H04W 16/14; H04W 84/18; H04W 88/08

(52) U.S. Cl. CPC H04B 7/2609; H04W 16/14; H04W 84/18; H04W 88/085

(57) ABSTRACT

Systems and methods for expanding coverage of a cellular network are described herein. In an aspect, a system includes a BBU entity and RU's which include at least one donor RU communicatively coupled to the BBU entity via a wired connection and at least one mesh RU communicatively coupled to the at least one donor RU via a wireless connection. The at least one mesh RU is communicatively coupled to the BBU entity via the at least one donor RU. The at least one donor RU is configured to communicate fronthaul communications with the at least one mesh RU over the wireless connection. The system includes antennas communicatively coupled to the RUs, wherein each RU is communicatively coupled to a respective subset of the antennas. The BBU entity, the RUs, and the antennas are configured to implement a base station for wirelessly communicating with UEs.

### CROSS-REFERENCE TO RELATED APPLICATIONS

This application claims benefit of U.S. Provisional Patent Application Ser. No. 63/350,816, filed on Jun. 9, 2022, entitled “CELLULAR MESH NETWORK FOR REMOTE RADIO UNITS,” the contents of which are incorporated herein in their entirety.

### BACKGROUND

A centralized or cloud radio access network (C-RAN) is one way to implement base station functionality. Typically, for each cell (that is, for each physical cell identifier (PCI)) implemented by a C-RAN, one or more baseband unit (BBU) entities (also referred to herein simply as “BBUs”) interact with multiple radio units (also referred to here as “RUs,” “remote units,” “radio points,” or “RPs”) in order to provide wireless service to various items of user equipment (UEs). The one or more BBU entities may comprise a single entity (sometimes referred to as a “baseband controller” or simply a “baseband band unit” or “BBU”) that performs Layer-3, Layer-2, and some Layer-1 processing for the cell. The one or more BBU entities may also comprise multiple entities, for example, one or more central units (CU) entities that implement Layer-3 and non-time critical Layer-2 functions for the associated base station and one or more distributed units (DUs) that implement the time critical Layer-2 functions and at least some of the Layer-1 (also referred to as the Physical Layer) functions for the associated base station. Each CU can be further partitioned into one or more user-plane and control-plane entities that handle the user-plane and control-plane processing of the CU, respectively. Each such user-plane CU entity is also referred to as a “CU-UP,” and each such control-plane CU entity is also referred to as a “CU-CP.” In this example, each RU is configured to implement the radio frequency (RF) interface and the physical layer functions for the associated base station that are not implemented in the DU. The multiple radio units may be located remotely from each other (that is, the multiple radio units are not co-located) or collocated (for example, in instances where each radio unit processes different carriers or time slices), and the one or more BBU entities are communicatively coupled to the radio units over a fronthaul network.

### SUMMARY

In some aspects, a system includes at least one baseband unit entity and a plurality of radio units. The plurality of radio units includes at least one donor radio unit communicatively coupled to the at least one baseband unit entity via a wired connection. The plurality of radio units also includes at least one mesh radio unit communicatively coupled to the at least one donor radio unit via a wireless connection. The at least one mesh radio unit is communicatively coupled to the at least one baseband unit entity via the at least one donor radio unit. The system further includes a plurality of antennas communicatively coupled to the plurality of radio units. Each respective radio unit of the plurality of radio units is communicatively coupled to a respective subset of the plurality of antennas. The at least one baseband unit entity, the plurality of radio units, and the plurality of antennas are configured to implement a base station for wirelessly communicating with user equipment. The at least one donor radio unit is configured to communicate fronthaul communications with the at least one mesh radio unit over the wireless connection.

In some aspects, a method of operation for a mesh radio unit includes conducting a cell search procedure. The method further includes establishing a wireless connection with at least one donor radio unit. The method further includes obtaining network configuration details from a management system. The method further includes receiving downlink fronthaul communications from the at least one donor radio unit via the wireless connection. The method further includes transmitting downlink communications to user equipment based on the downlink fronthaul communications.

### BRIEF DESCRIPTION OF THE DRAWINGS

Understanding that the drawings depict only exemplary embodiments and are not therefore to be considered limiting in scope, the exemplary embodiments will be described with additional specificity and detail through the use of the accompanying drawings, in which:

FIGS. 1A-1B are block diagrams illustrating example wireless systems which include mesh remote radio units;

FIG. 2 is a block diagram illustrating an example wireless system which includes mesh remote radio units; and

FIG. 3 is a flow diagram illustrating an example method of operation for a mesh radio unit of a wireless network.

In accordance with common practice, the various described features are not drawn to scale but are drawn to emphasize specific features relevant to the exemplary embodiments.

### DETAILED DESCRIPTION

In the following detailed description, reference is made to the accompanying drawings that form a part hereof, and in which is shown by way of illustration specific illustrative embodiments. However, it is to be understood that other embodiments may be used and that logical, mechanical, and electrical changes may be made. Furthermore, the method presented in the drawing figures and the specification is not to be construed as limiting the order in which the individual acts may be performed. The following detailed description is, therefore, not to be taken in a limiting sense.

After initial deployment of a wireless network, there is often a desire or need to extend coverage of the network to surrounding areas. For example, it may be desirable to extend cellular coverage from an initial indoor deployment in a building to other areas outside of the building. Typically, the process of adding new radio units to extend the cellular coverage can be time consuming and expensive due to, at least in part, installation of the wired fronthaul between the baseband unit entity and the remote radio units that will serve the expanded coverage area.

The systems and methods described herein utilize a combination of wired and wireless connections to facilitate less time consuming and less expensive extension of cellular coverage for a wireless network. The systems and methods described herein expand the coverage of a wireless network by using one or more mesh radio units that are communicatively coupled to the baseband unit entity via one or more donor radio units. The donor radio units are communicatively coupled to the baseband unit entity via a wired connection, and the mesh radio units are communicatively coupled to the donor radio units via a wireless connection, which is used for fronthaul communications. The wireless connection can be implemented using in-band channels that are also used for communication with user equipment or using out-of-band channels that are not used for communication with user equipment. In some examples, a first mesh radio unit can also act as a donor for a second mesh radio unit such that the second mesh radio unit is communicatively coupled to the baseband unit entity via a donor radio unit and the first mesh radio unit.

The term “channels” used herein refers to the various physical channels for a given cell (that is, for a given physical cell identifier (PCI)) as defined by the underlying air interface. Some example physical channels include the Physical Downlink Control Channel (PDCCH), Physical Broadcast Channel (PBCH), Physical Downlink Shared Channel (PDSCH), Physical Random Access Channel (PRACH), Physical Uplink Control Channel (PUCCH), and Physical Uplink Shared Channel (PUSCH). In this context, the term “in-band channels” used herein refers to the physical channels used for the wireless service being provided to UEs via the RAN in a given cell. In contrast, the term “out-of-band channels” used herein refers to physical channels that are not used for the wireless service being provided to UEs via the RAN in a given cell.

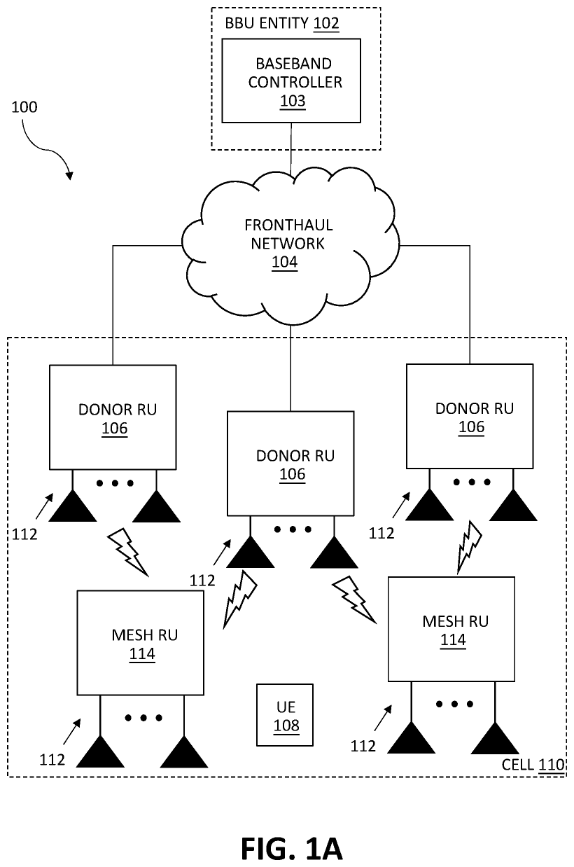

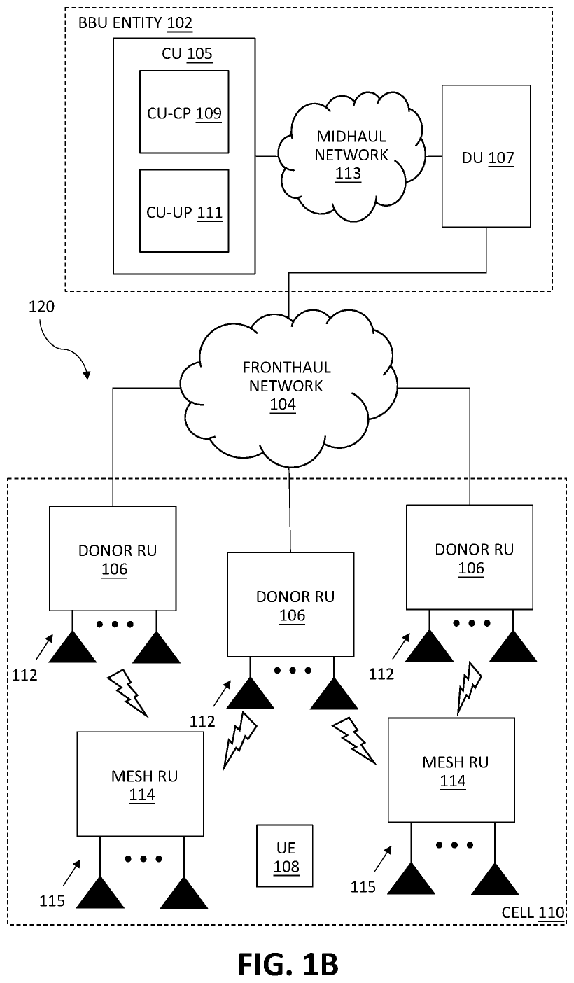

FIGS. 1A-1B illustrate block diagrams of example base stations 100, 120. In the particular examples shown in FIGS. 1A-1B, the base stations 100, 120 include one or more baseband unit (BBU) entities 102 communicatively coupled to multiple donor radio units (RUS) 106 and multiple mesh RUs 114. Each donor RU 106 and mesh RU 114 is typically located remotely from the one or more BBU entities 102 and located remotely from other donor RUs 106 and mesh RUs 114. The base stations 100, 120 provide wireless service to various user equipment (UEs) 108 in a cell 110.

In the example shown in FIG. 1A, the one or more BBU entities 102 comprise one or more baseband controllers 103. Each baseband controller 103 performs Layer-3, Layer-2, and some Layer-1 processing for the cell 110. The baseband controller 103 is communicatively coupled to donor RUs 106 over a fronthaul network 104, which includes one or more wired connections between the donor RUs 106 and the baseband controller 103. In some examples, the fronthaul network 104 is a switched Ethernet fronthaul network (for example, a switched Ethernet network that supports the Internet Protocol (IP)). In the example shown in FIG. 1A, the donor RUs 106 are configured to implement the radio frequency (RF) interface and the physical layer functions for the associated base station that are not implemented in the baseband controller 103.

In the example shown in FIG. 1A, the mesh RUs 114 are also configured to implement the RF interface and the physical layer functions for the associated base station that are not implemented in the baseband controller 103. In the example shown in FIG. 1A, the baseband controller 103 is communicatively coupled to mesh RUs 114 via the fronthaul network 104 and one or more wireless connections between the mesh RUs 114 and the donor RUs 106. Accordingly, the fronthaul between the baseband controller 103 and the mesh RUs 114 is implemented using a combination of wired connections (via the fronthaul network 104) and wireless connections (via the donor RUs 106).

In the example shown in FIG. 1B, the one or more BBU entities 102 comprise one or more CUs 105 and one or more DUs 107. Each CU 105 implements Layer-3 and non-time critical Layer-2 functions for the cell 110. Each DU 107 is configured to implement the time critical Layer-2 functions and at least some of the Layer-1 (also referred to as the Physical Layer) functions for the cell 110. Each CU 105 can be further partitioned into one or more control-plane and user-plane entities 109, 111 that handle the control-plane and user-plane processing of the CU 105, respectively. Each such control-plane CU entity 109 is also referred to as a “CU-CP” 109, and each such user-plane CU entity 111 is also referred to as a “CU-UP” 111.

In the example shown in FIG. 1B, the donor RUs 106 are configured to implement the control-plane and user-plane Layer-1 functions not implemented by the DU 107 as well as the RF functions. In the example shown in FIG. 1B, each donor RU 106 is implemented as a physical network function (PNF) and is deployed in or near a physical location where radio coverage is to be provided in the cell 110. In the example shown in FIG. 1B, the donor RUs 106 are communicatively coupled to the DU 107 using a fronthaul network 104, which includes one or more wired connections between the donor RUs 106 and the DU 107. In some examples, the fronthaul network 104 is a switched Ethernet fronthaul network (for example, a switched Ethernet network that supports the Internet Protocol (IP)).

In the example shown in FIG. 1B, the mesh RUs 114 are also configured to implement the control-plane and user-plane Layer-1 functions not implemented by the DU 107 as well as the RF functions. In the example shown in FIG. 1B, each mesh RU 114 is implemented as a physical network function (PNF) and is deployed in or near a physical location where radio coverage is to be provided in the cell 110. In the example shown in FIG. 1B, the DU 107 is communicatively coupled to mesh RUs 114 via the fronthaul network 104 and one or more wireless connections between the mesh RUs 114 and the donor RUs 106. Accordingly, the fronthaul between the DU 107 and the mesh RUs 114 is implemented using a combination of wired connections (via the fronthaul network 104) and wireless connections (via the donor RUs 106).

Each of the donor RUs 106 includes or is coupled to a respective set of antennas 112 via which downlink RF signals are radiated to UEs 108 and via which uplink RF signals transmitted by UEs 108 are received. In some examples, each set of antennas 112 includes two or four antennas. However, it should be understood that each set of antennas 112 can include one or more antennas 112. In one configuration (used, for example, in indoor deployments), each donor RU 106 is co-located with its respective set of antennas 112 and is remotely located from the one or more BBU entities 102 serving it and the other donor RUs 106. In another configuration (used, for example, in outdoor deployments), the sets of antennas 112 for the RUs 106 are deployed in a sectorized configuration (for example, mounted at the top of a tower or mast). In such a sectorized configuration, the donor RUs 106 need not be co-located with the respective sets of antennas 112 and, for example, can be located at the base of the tower or mast structure, for example, and, possibly, co-located with the serving one or more BBU entities 102. Other configurations can be used.

Each of the mesh RUs 114 includes or is coupled to a respective set of antennas 115 via which downlink RF signals are radiated to UEs 108 and via which uplink RF signals transmitted by UEs 108 are received. In some examples, each set of antennas 115 includes two or four antennas. However, it should be understood that each set of antennas 115 can include one or more antennas 115. In one configuration (used, for example, in indoor deployments), each mesh RU 114 is co-located with its respective set of antennas 115 and is remotely located from the one or more BBU entities 102 and the donor RUs 106 serving it. Other configurations can be used. In general, configurations with donor RUs 106 and mesh RUs 114 distributed throughout the UE 108 environment provide better performance for extending the coverage of the network compared to configurations with collocated donor RUs 106 and/or collocated antennas 112.

The base stations 100, 120 that include the components shown in FIGS. 1A-1B can be implemented using a scalable cloud environment in which resources used to instantiate each type of entity can be scaled horizontally (that is, by increasing or decreasing the number of physical computers or other physical devices) and vertically (that is, by increasing or decreasing the “power” (for example, by increasing the amount of processing and/or memory resources) of a given physical computer or other physical device). The scalable cloud environment can be implemented in various ways. For example, the scalable cloud environment can be implemented using hardware virtualization, operating system virtualization, and application virtualization (also referred to as containerization) as well as various combinations of two or more of the preceding. The scalable cloud environment can be implemented in other ways. In some examples, the scalable cloud environment is implemented in a distributed manner. That is, the scalable cloud environment is implemented as a distributed scalable cloud environment comprising at least one central cloud, at least one edge cloud, and at least one radio cloud.

In some examples, one or more components of the one or more BBU entities 102 (for example, the CU 105, CU-CP 109, CU-UP 111, and/or DU 107) are implemented as a software virtualized entities that are executed in a scalable cloud environment on a cloud worker node under the control of the cloud native software executing on that cloud worker node. In some such examples, the DU 107 is communicatively coupled to at least one CU-CP 109 and at least one CU-UP 111, which can also be implemented as software virtualized entities. In some other examples, one or more components of the one or more BBU entities 102 (for example, the CU-CP 109, CU-UP 111, and/or DU 107) are implemented as a single virtualized entity executing on a single cloud worker node. In some examples, the at least one CU-CP 109 and the at least one CU-UP 111 can each be implemented as a single virtualized entity executing on the same cloud worker node or as a single virtualized entity executing on a different cloud worker node. However, it is to be understood that different configurations and examples can be implemented in other ways. For example, the CU 105 can be implemented using multiple CU-UP VNFs and using multiple virtualized entities executing on one or more cloud worker nodes. Moreover, it is to be understood that the CU 105 and DU 107 can be implemented in the same cloud (for example, together in a radio cloud or in an edge cloud). In some examples, the DU 107 is configured to be coupled to the CU-CP 109 and CU-UP 111 over a midhaul network 113 (for example, a network that supports the Internet Protocol (IP)). Other configurations and examples can be implemented in other ways.

Each respective donor RU 106 is generally configured to treat the mesh RUs 114 communicatively coupled to the respective donor RU 106 like an end user device in that a wireless connection is established between the donor RU 106 and the mesh RU 114, and the donor RU 106 transmits/receives communications to/from the mesh RU 114. However, the respective donor RU 106 is configured to exchange fronthaul communications with the mesh RUs 114 rather than data packets as with UEs 108. In some examples, the donor RUs 106 are configured to transmit downlink IQ samples to the mesh RUs 114 via the wireless connections and receive uplink IQ samples from the mesh RUs 114 via the wireless connections. Other types of fronthaul communications can also be communicated between the donor RUs 106 and the mesh RUs 114.

The mesh RU 114 needs to connect to the network prior to being able to exchange fronthaul communications with the donor RUs 106 or data packets with the UEs 108. Upon activation of the mesh RU 114, the mesh RU 114 is configured to perform a UE-like cell search procedure in order to start the process of identifying and connecting to the network. In some examples, the mesh RU 114 is configured to perform the cell search procedure using in-band channels used for wireless communication between the donor RUs 106 and UEs 108. In some examples, the UE-like cell search procedure includes the mesh RU 114 acquiring time and frequency synchronization with the base station 100, 120 using synchronization signals (for example, Primary Synchronization Signals (PSSs), Secondary Synchronization Signals (SSSs), Synchronization Signal Block (SSBs)) transmitted by the donor RUs 106. In some examples, the mesh RU 114 attempts to establish a wireless connection with at least one donor RU 106 using a certificate-based authentication procedure. Other types of authentication procedures could also be used. In general, the authentication flow for the mesh RUs 114 is locally performed within the RAN and does not require the entire flow as defined in 3GPP for UEs 108.

Once the wireless connection between the donor RU 106 and the mesh RU 114 is established, the mesh RU 114 homes to a management system (for example, a Device Management System (DMS)) used for configuration of the network devices in order to register with the management system. This registration process is similar to that used for registration of the donor RUs 106. Once the mesh RU 114 is registered with the management system, the management system provides (or the mesh RU 114 otherwise downloads) configuration details for the network and for the mesh RU 114. The configuration details for the network can include information regarding the channels used by the network, power levels for transmission, and the like. In some examples, the management system is configured to provide the configuration details over the O1 interface. Once the mesh RU 114 is configured using the configuration details provided by the management system, the mesh RU 114 can be used for communications with UEs 108.

In some examples, multiple donor RUs 106 are configured to transmit downlink fronthaul communications to a single mesh RU 114. In some such examples, the system is configured to determine the particular donor RUs 106 in proximity to the mesh RU 114. This determination can be made, for example, by measuring a power level of uplink signals from the mesh RU 114 at different donor RUs 106 and determining whether the measured power level of the uplink signals from the mesh RU 114 exceeds a threshold. In some examples where multiple donor RUs 106 are to be used for transmitting downlink fronthaul communications to the mesh RU 114, the one or more BBU entities 102 are configured to transmit the packets destined for the mesh RU 114 using multicast groups that only send the downlink fronthaul communications to the particular donor RUs 106 that are determined to be in proximity to the mesh RU 114. In some such examples, the particular donor RUs 106 transmit the downlink fronthaul communications to the mesh RU 114 using the same channel and PCI. In some examples, each donor RU 106 communicatively coupled to the mesh RU 114 is configured to transmit the same downlink fronthaul communications to the mesh RU 114. In other examples, the downlink fronthaul communications for a particular mesh RU 114 can be split across different donor RUs 106 such that each donor RU 106 transmits a different portion of the downlink fronthaul communications destined for that particular mesh RU 114.

In the downlink, the fronthaul traffic from the one or more BBU entities 102 destined for UEs 108 needs to be handled differently than the fronthaul traffic (for example, precoded IQ traffic) destined for mesh RUs 114. In some examples, the one or more BBU entities 102 are configured to mark packets of the downlink fronthaul communications to indicate whether the packets are destined for mesh RUs 114. In some such examples, the one or more BBU entities 102 are configured to mark the packets by modifying a reserved value in the Logical Channel ID (LCID). In other examples, different techniques can be used to mark the packets.

In some examples, the donor RUs 106 are configured to determine the destination of the downlink fronthaul traffic and process the downlink fronthaul traffic differently depending on the intended destination of the downlink fronthaul traffic. In examples where the one or more BBU entities 102 mark the packets as described above, the donor RUs 106 are configured to determine the destination of the downlink fronthaul traffic and process the downlink fronthaul traffic based on the marking of the packets. Packets destined for UEs 108 will be wirelessly communicated to the UEs 108 by the donor RUs 106 while packets destined for the mesh RUs 114 will be wirelessly communicated to the mesh RUs 114 as discussed below.

The wireless fronthaul communications between the mesh RU 114 and the donor RUs 106 can be implemented using licensed spectrum, shared licensed spectrum, or unlicensed spectrum. While the initial wireless communications between the donor RU 106 and the mesh RU 114 use in-band channels for establishing the wireless connection between the donor RU 106 and the mesh RU 114 (for example, using the customized cell search procedure), the wireless fronthaul communications between the donor RUs 106 and the mesh RU 114, which take place after the registration process is complete, can be implemented using in-band channels or out-of-band channels depending on the desired performance of the network.

In some examples, the communication of the fronthaul data between the mesh RU 114 and the donor RUs 106 is implemented using in-band channels. In some examples, the wireless fronthaul communications are implemented using channels that are in the frequency bands used for wireless communication between the donor RUs 106 and UEs 108. The use of the same frequency bands can reduce the bandwidth available for wireless communication to UEs 108 using the donor RUs 106 coupled to the one or more BBU entities 102 using a wired connection because some slots meant for serving UEs 108 are used for communicating with the mesh RU 114. This leads to the mesh RU 114 contending for the same resources as UEs 108 and can lead to a reduction in the capacity of the network in some situations.

In some such examples, the mesh RUs 114 may only be able listen to the donor RUs 106 or transmit to the intended UEs 108, but not at the same time. In other words, there may be some time slots where the mesh RU 114 does not receive downlink fronthaul communications intended for the mesh RU 114 from the one or more BBU entities 102 (for example, control information, etc.). To avoid missing downlink fronthaul communications, in some examples, the mesh RUs 114 can be configured to operate in a dynamic TDD configuration for in-band communication so transmission of fronthaul communications from the donor RU 106 and corresponding reception of the fronthaul communications by the mesh RU 114 is scheduled at a different time than transmission/reception of downlink/uplink packets to/from UEs 108 by the mesh RU 114.

In other examples, the communication of the fronthaul data between the mesh RU 114 and the donor RUs 106 is implemented using out-of-band channels. In some examples, the fronthaul communications are implemented using channels that are outside the frequency bands used for wireless communication between the donor RUs 106 and UEs 108. In some examples, the out-of-band channels are in the Citizens Broadband Radio Service (CBRS) band of frequencies that are allocated or earmarked for mesh communication rather than end user service. In other examples, the out-of-band channels are in another band of frequencies that are different than those used for wireless communications between the donor RUs 106 and UEs 108. The use of different frequency bands helps to avoid the issues with mesh RUs 114 and UEs 108 contending for the same resources compared to using in-band channels discussed above, and the mesh RUs 114 have the same capacity as the donor RUs 106. However, the use of these separate frequency bands can increase the cost of the donor RUs 106 coupled to the one or more BBU entities 102 using a wired connection because additional transceiver equipment may be required for the wireless communications with the mesh RUs 114.

In some examples, it is possible for one or more mesh RUs to serve as a donor for other mesh RUs in the network. Such a configuration can provide more flexibility for deployment as the coverage of the network can be extended by another layer of mesh RUs (for example, in a daisy chain configuration).

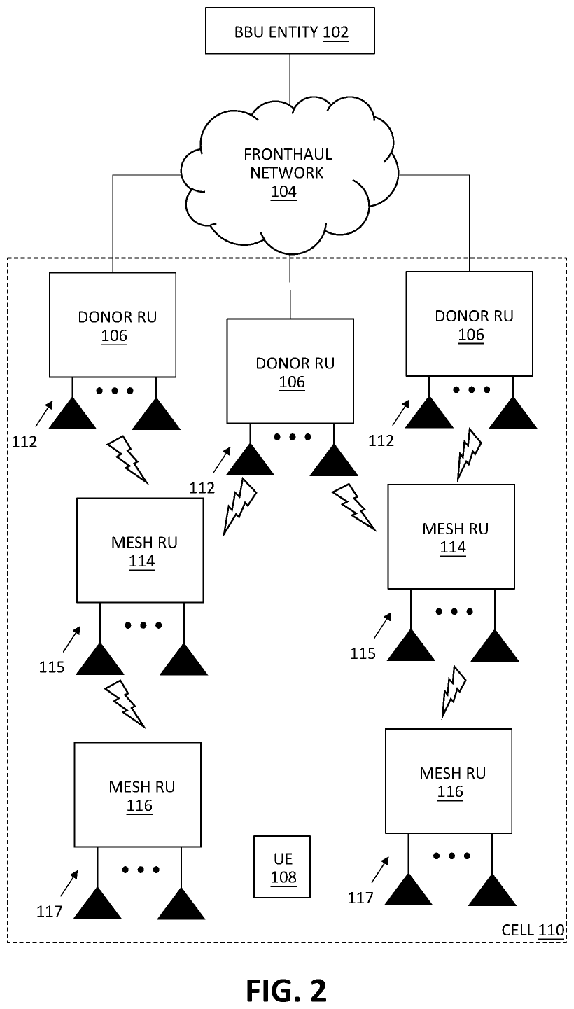

FIG. 2 illustrates a block diagram of an example base station 200 where mesh RUs 114 serve as a donor for other mesh RUs 116. The base station 200 includes similar components to the base stations 100, 120 that are described above with respect to FIGS. 1A-1B. The functions, structures, and other description of common elements of the base stations 100, 120 discussed above with respect to FIGS. 1A-1B are also applicable to like named features in the base station 200 shown in FIG. 2 and vice versa. Further, like named features included in FIGS. 1A-1B and 2 are numbered similarly. The description of FIG. 2 will focus on the differences from FIGS. 1A-1B.

In the particular example shown in FIG. 2, the base station 200 further includes another layer of mesh RUs 116 that are communicatively coupled to the mesh RUs 114 via one or more wireless connections. The mesh RUs 114 serve as a donor for fronthaul communications between the one or more BBU entities 102 and the additional layer of mesh RUs 116. In examples where the one or more BBU entities 102 include a baseband controller 103 (such as the example shown in FIG. 1A), the mesh RUs 116 are also configured to implement the radio frequency (RF) interface and the physical layer functions for the associated base station that are not implemented in the baseband controller 103. In examples where the one or more BBU entities 102 include a CU 105 and DU 107, the mesh RUs 116 are configured to implement the control-plane and user-plane Layer-1 functions not implemented by the DU 107 as well as the radio frequency (RF) functions.

Each mesh RU 116 is implemented as a physical network function (PNF) and is deployed in or near a physical location where radio coverage is to be provided in the cell 110. In the example shown in FIG. 2, the one or more BBU entities 102 are communicatively coupled to mesh RUs 116 via the fronthaul network 104, one or more wireless connections between the mesh RUs 114 and the donor RUs 106, and one or more wireless connections between the mesh RUs 116 and the mesh RUs 114. Accordingly, the fronthaul between the one or more BBU entities 102 and the mesh RUs 116 is implemented using a combination of wired connections (via the fronthaul network 104) and wireless connections (via the donor RUs 106 and mesh RUs 114).

Each of the mesh RUs 116 includes or is coupled to a respective set of antennas 117 via which downlink RF signals are radiated to UEs 108 and via which uplink RF signals transmitted by UEs 108 are received. In some examples, each set of antennas 117 includes two or four antennas. However, it should be understood that each set of antennas 117 can include one or more antennas 117. In one configuration (used, for example, in indoor deployments), each mesh RU 116 is co-located with its respective set of antennas 117 and is remotely located from the one or more BBU entities 102, the donor RUs 106, and the mesh RUs 114 serving it. Other configurations can be used. In general, configurations with donor RUs 106, mesh RUs 114, and mesh RUs 116 distributed throughout the UE 108 environment provide better performance for extending the coverage of the network compared to configurations with collocated donor RUs 106 and/or collocated antennas 112.

Similar to the donor RUs 106, each respective mesh RU 114 is generally configured to treat the mesh RUs 116 communicatively coupled to the respective mesh RU 114 like an end user device in that a wireless connection is established between the mesh RU 114 and the mesh RU 116, and the mesh RU 114 transmits/receives communications to/from the mesh RU 116. However, the respective mesh RU 114 is configured to exchange fronthaul communications with the mesh RUs 116 rather than data packets as with UEs 108. In some examples, the mesh RUs 114 are configured to transmit downlink IQ samples to the mesh RUs 116 via the wireless connections and receive uplink IQ samples from the mesh RUs 116 via the wireless connections. Other types of fronthaul communications can also be communicated between the mesh RUs 114 and the mesh RUs 116.

The mesh RU 116 needs to connect to the network prior to being able to exchange fronthaul communications with the mesh RUs 114 or data packets with the UEs 108. Upon activation of the mesh RU 116, the mesh RU 116 is configured to perform a UE-like cell search procedure in order to start the process of identifying and connecting to the network. In some examples, the mesh RU 116 is configured to perform the cell search procedure using in-band channels used for wireless communication between the donor RUs 106 and UEs 108. In some examples, the UE-like cell search procedure includes the mesh RU 116 acquiring time and frequency synchronization with the base station 200 using synchronization signals (for example, Primary Synchronization Signals (PSSs), Secondary Synchronization Signals (SSSs), Synchronization Signal Block (SSBs)) transmitted by the donor RUs 106 and/or the mesh RUs 114. In some examples, the mesh RU 116 attempts to establish a wireless connection with at least one mesh RU 114 using a certificate-based authentication procedure. Other types of authentication procedures could also be used. In general, the authentication flow for the mesh RUs 116 is locally performed within the RAN and does not require the entire flow as defined in 3GPP for UEs 108.

Once the wireless connection between the mesh RU 114 and the mesh RU 116 is established, the mesh RU 116 homes to a management system (for example, a Device Management System (DMS)) used for configuration of the network devices in order to register with the management system. This registration process is similar to that used for registration of the donor RUs 106. Once the mesh RU 116 is registered with the management system, the management system provides (or the mesh RU 116 otherwise downloads) configuration details for the network and for the mesh RU 116. The configuration details for the network can include information regarding the channels used by the network, power levels for transmission, and the like. In some examples, the management system is configured to provide the configuration details over the O1 interface. Once the mesh RU 116 is configured using the configuration details provided by the management system, the mesh RU 116 can be used for communications with UEs 108.

In some examples, multiple mesh RUs 114 are configured to transmit downlink fronthaul communications to a single mesh RU 116. In some such examples, the system is configured to determine the particular mesh RUs 114 in proximity to the mesh RU 116. This determination can be made, for example, by measuring a power level of uplink signals from the mesh RU 116 at different mesh RUs 114 and determining whether the measured power level of the uplink signals from the mesh RU 116 exceeds a threshold. In some examples where multiple mesh RUs 114 are to be used for transmitting downlink fronthaul communications to the mesh RU 116, the one or more BBU entities 102 are configured to transmit the packets destined for the mesh RU 116 using multicast groups that only send the downlink fronthaul communications to the particular mesh RUs 114 that are determined to be in proximity to the mesh RU 116. In some such examples, the particular mesh RUs 114 transmit the downlink fronthaul communications to the mesh RUs 116 using the same channel and PCI. In some examples, each mesh RU 114 communicatively coupled to the mesh RU 116 is configured to transmit the same downlink fronthaul communications to the mesh RU 116. In other examples, the downlink fronthaul communications for a particular mesh RU 116 can be split across different mesh RUs 114 such that each mesh RU 114 transmits a different portion of the downlink fronthaul communications destined for that particular mesh RU 116.

In the downlink, the fronthaul traffic from the one or more BBU entities 102 destined for UEs 108 needs to be handled differently than the fronthaul traffic (for example, precoded IQ traffic) destined for mesh RUs 116. In some examples, the one or more BBU entities 102 are configured to mark packets of the downlink fronthaul communications to indicate whether the packets are destined for mesh RUs 116 in a manner similar to that described above.

In some examples, the donor RUs 106 and the mesh RUs 114 are configured to determine the destination of the downlink fronthaul traffic and process the downlink fronthaul traffic differently depending on the intended destination of the downlink fronthaul traffic. In examples where the one or more BBU entities 102 mark the packets as described above, the donor RUs 106 and the mesh RUs 114 are configured to determine the destination of the downlink fronthaul traffic and process the downlink fronthaul traffic based on the marking of the packets. Packets destined for UEs 108 will be wirelessly communicated to the UEs 108 by the donor RUs 106 or the mesh RUs 114 while packets destined for the mesh RUs 116 will be wirelessly communicated to the mesh RUs 116 as discussed below. It should be noted that there is a slot of latency for the mesh RUs 114 to decode the fronthaul communications from the donor RUs 106 prior to making the above-described determination.

The wireless fronthaul communications between the mesh RUs 116 and the mesh RUs 114 can be implemented using licensed spectrum, shared licensed spectrum, or unlicensed spectrum. While the initial wireless communications between the mesh RUs 114 and the mesh RUs 116 are in-band for establishing the wireless connection between the mesh RUs 114 and the mesh RUs 116 (for example, using the customized cell search procedure), the wireless fronthaul communications between the mesh RUs 114 and the mesh RUs 116, which take place after the registration process is complete, can be implemented using in-band channels or out-of-band channels depending on the desired performance of the network.

In some examples, the channels used for the wireless fronthaul communications between the mesh RUs 114 and the mesh RUs 116 are the same as those used for the wireless communications between the donor RUs 106 and the mesh RUs 114 and for wireless communications between the donor RUs 106 and UEs 108. The use of the same frequency bands can reduce the bandwidth available for wireless communication to UEs 108 by the mesh RUs 114 (and the donor RUs 106 when using in-band channels) because some slots meant for serving UEs 108 are used for communicating with the mesh RUs 116. This leads to the mesh RUs 116 contending for the same resources as UEs 108 and can lead to a reduction in the capacity of the network in some situations.

In some such examples, the mesh RUs 116 may only be able listen to the mesh RUs 114 or transmit to the intended UEs 108, but not at the same time. In other words, there may be some time slots where the mesh RU 116 does not receive downlink fronthaul communications intended for the mesh RU 116 from the one or more BBU entities 102 (for example, control information, etc.). To avoid missing downlink fronthaul communications, in some examples, the mesh RUs 116 can be configured to operate in a dynamic TDD for in-band communication so transmission of fronthaul communications from the mesh RU 114 and corresponding reception of the fronthaul communications by the mesh RU 116 is scheduled at a different time than transmission/reception of downlink/uplink packets to/from UEs 108 by the mesh RU 116.

In other examples, the channels used for the wireless fronthaul communications between the mesh RUs 114 and the mesh RUs 116 are different than those used for the wireless communications between the donor RUs 106 and the mesh RUs 114 and for wireless communications between the donor RUs 106 and UEs 108. The use of different frequency bands helps to avoid the issues with mesh RUs 116 and UEs 108 contending for the same resources compared to using the same channels as discussed above, and the mesh RUs 116 have the same capacity as the donor RUs 106 and the mesh RUs 114. However, the use of these separate frequency bands can increase the cost of the mesh RUs 114 because additional transceiver equipment may be required for the wireless communications with the mesh RUs 116.

In the examples shown in FIGS. 1A-2, the donor RUs 106, mesh RUs 114, and mesh RUs 116 are all included in the same cell 110. In such examples, the donor RUs 106, mesh RUs 114, and mesh RUs 116 are all considered to be part of the same Physical Cell Identifier (PCI), and the UEs 108 see the same PCI and channel(s) from the donor RUs 106, mesh RUs 114, and mesh RUs 116.

In other examples, the mesh RUs 116 can be included in a different cell than the cell 110 that includes the donor RUs 106 and the mesh RUs 114. In such examples, the mesh RUs 116 are considered to be part of a different PCI compared to the donor RUs 106 and the mesh RUs 114, and the UEs 108 see a different PCI and channel(s) from the mesh RUs 116 compared to the donor RUs 106 and the mesh RUs 114. In such examples, the cell 110 that includes the donor RUs 106 and the mesh RUs 114 and the cell that includes the mesh RUs 116 are two adjacent, disjoint cells from the perspective of the UEs 108. This scenario can offer independent cell coverage using the mesh RUs 116.

In other examples, the mesh RUs 114 and the mesh RUs 116 can both be included in a different cell than the cell 110 that includes the donor RUs 106. In some such examples, the mesh RUs 114 and the mesh RUs 116 are included in the same cell. In such examples, the mesh RUs 114 and the mesh RUs 116 are considered to be part of a different PCI compared to the donor RUs 106, and the UEs 108 see a different PCI and channel(s) from the mesh RUs 114 and the mesh RUs 116 compared to the donor RUs 106. In such examples, the cell 110 that includes the donor RUs 106 and the cell that includes the mesh RUs 114 and the mesh RUs 116 are two adjacent, disjoint cells from the perspective of the UEs 108. This scenario can offer independent cell coverage using the mesh RUs 114 and the mesh RUs 116.

In other examples, the mesh RUs 114 and the mesh RUs 116 can each be included in respective different cells than the cell 110 that includes the donor RUs 106. In such examples, the mesh RUs 114 are considered to be part of a different PCI compared to the donor RUs 106 and the mesh RUs 114, and the UEs 108 see a different PCI and channel(s) from the donor RUs 106, the mesh RUs 114, and the mesh RUs 116. In such examples, the cell 110 that includes the donor RUs 106 and the cell that includes the mesh RUs 114 are two adjacent, disjoint cells from the perspective of the UEs 108. Similarly, the cell that includes the mesh RUs 114 and the cell that includes the mesh RUs 116 are two adjacent, disjoint cells from the perspective of the UEs 108. This scenario can offer independent cell coverage using the mesh RUs 114 and further independent cell coverage using the mesh RUs 116.

In all of the above scenarios, the mesh RUs 114 and the mesh RUs 116 share the same scheduler (for example, the baseband controller 103 or DU 107) as the donor RUs 106 in the cell 110.

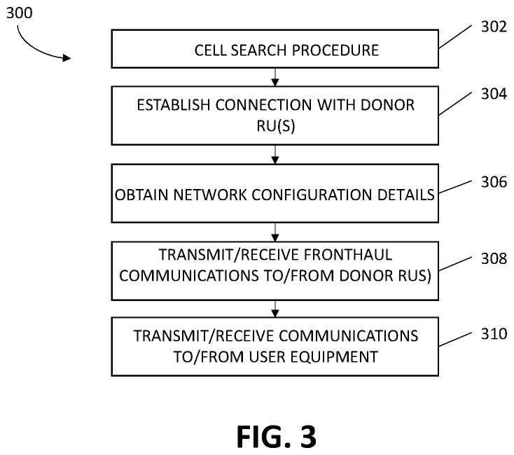

FIG. 3 is a flow diagram of an example method 300 of operation for a mesh radio unit in a wireless network. The example method 300 shown in FIG. 3 is described herein as being implemented using the base stations 100, 120, 200 shown in FIGS. 1A-2. It is to be understood that other examples can be implemented in other ways.

The blocks of the flow diagram in FIG. 3 have been arranged in a generally sequential manner for ease of explanation; however, it is to be understood that this arrangement is merely exemplary, and it should be recognized that the processing associated with method 300 (and the blocks shown in FIG. 3) can occur in a different order (for example, where at least some of the processing associated with the blocks is performed in parallel in an event-driven manner).

The method 300 can be performed by a mesh RU upon activation. In some examples, each mesh RU to be utilized for a base station performs method 300 upon activation. It should be noted that the method 300 can be implemented by a mesh RU that is in the first layer of mesh RUs (such as, for example, mesh RUs 114 in FIGS. 1A-2) or by a mesh RU that is in a subsequent layer of mesh RUs (such as, for example, mesh RUs 116 in FIG. 2).

The method 300 includes performing a cell search procedure (block 302). In some examples, performing the cell search procedure is similar to the cell search procedure used by a UE with some variations. In some examples, the cell search procedure includes acquiring time and frequency synchronization with the base station using synchronization signals (for example, Primary Synchronization Signals (PSSs), Secondary Synchronization Signals (SSSs), Synchronization Signal Block (SSBs)). The cell search procedure is implemented using in-band channels that are also used for wireless communications between donor RUs and UEs.

The method 300 further includes establishing a wireless connection with donor RU(s) (block 304). In some examples, establishing a wireless connection includes using an authentication procedure (for example, using certificates).

The method 300 further includes obtaining network configuration details (block 306). In some examples, the mesh RU homes to a management system (for example, a DMS) to register and obtain the network configuration details, which is similar to a registration process used by the donor RUs that are coupled to the BBU entity using a wired connection. In such examples, the management system is configured to provide, or the mesh RU is configured to download, the configuration details for the network and the mesh RU. The configuration details can include, for example, the channels used by the network, power levels, etc. Once the mesh RU is configured using configuration details from the management system, the mesh RU is considered part of the existing network, which extends the coverage beyond the original deployment that included the donor RUs.

The method 300 further includes transmitting/receiving fronthaul communications to/from donor RUs (block 308). In some examples, the fronthaul communications between the mesh RU and the donor RUs are implemented using in-band channels. In some examples, the fronthaul communications are implemented using channels that are in the frequency bands used for wireless communication between the donor RUs and UEs. In other examples, the fronthaul communications between the mesh RU and the donor RUs are implemented using out-of-band channels. In some examples, the fronthaul communications are implemented using channels that are outside the frequency bands used for wireless communication between the donor RUs and UEs. In some such examples, the out-of-band channels are in the Citizens Broadband Radio Service (CBRS) band of frequencies. In other examples, the out-of-band channels are in a different band of frequencies that are different than those used for wireless communications between the donor RUs and UEs.

The method 300 further includes transmitting/receiving communications to/from user equipment (block 310). In some examples, the mesh RU is part of the same PCI as the donor RU(s), and the UEs 108 see the same PCI and channel(s) from the donor RUs as from the mesh RU. In other examples, the mesh RU is part of a different PCI than the donor RU(s), and the UEs 108 see a different PCI and channel(s) from the mesh RU compared to the donor RUs.

By utilizing the techniques described above, the coverage of a network can be extended without requiring wired fronthaul network infrastructure to be installed. This enables a network to be extended from an original deployment in a shorter amount of time and for less cost than if wired infrastructure needed to be installed. The techniques described herein can be utilized for a variety of uses cases including, but not limited to, extending cellular coverage from indoor deployments to outdoor areas (for example, parking lots, garden areas, or the like), extending cellular coverage from outdoor deployments (for example, strand mount RUs) to indoor areas, and extending cellular coverage for manufacturing/industrial networks (for example, in a factory or warehouse).

The methods and techniques described here may be implemented in digital electronic circuitry, or with a programmable processor (for example, a special-purpose processor or a general-purpose processor such as a computer) firmware, software, or in combinations of them. Apparatus embodying these techniques may include appropriate input and output devices, a programmable processor, and a storage medium tangibly embodying program instructions for execution by the programmable processor. A process embodying these techniques may be performed by a programmable processor executing a program of instructions to perform desired functions by operating on input data and generating appropriate output. The techniques may advantageously be implemented in one or more programs that are executable on a programmable system including at least one programmable processor coupled to receive data and instructions from, and to transmit data and instructions to, a data storage system, at least one input device, and at least one output device. Generally, a processor will receive instructions and data from a read-only memory and/or a random-access memory. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and DVD disks. Any of the foregoing may be supplemented by, or incorporated in, specially-designed application-specific integrated circuits (ASICs).

### Example Embodiments

Example 1 includes a system, comprising: at least one baseband unit entity; a plurality of radio units including: at least one donor radio unit communicatively coupled to the at least one baseband unit entity via a wired connection; and at least one mesh radio unit communicatively coupled to the at least one donor radio unit via a wireless connection, wherein the at least one mesh radio unit is communicatively coupled to the at least one baseband unit entity via the at least one donor radio unit; and a plurality of antennas communicatively coupled to the plurality of radio units, wherein each respective radio unit of the plurality of radio units is communicatively coupled to a respective subset of the plurality of antennas; wherein the at least one baseband unit entity, the plurality of radio units, and the plurality of antennas are configured to implement a base station for wirelessly communicating with user equipment; wherein the at least one donor radio unit is configured to communicate fronthaul communications with the at least one mesh radio unit over the wireless connection.

Example 2 includes the system of Example 1, wherein the at least one mesh radio unit is configured to conduct a cell search procedure using in-band channels, wherein the in-band channels are also used for wireless communications between the at least one donor radio unit and user equipment.

Example 3 includes the system of any of Examples 1-2, wherein the wireless connection between the at least one mesh radio unit and the at least one donor radio unit is implemented using in-band channels, wherein the in-band channels are also used for wireless communications between the at least one donor radio unit and user equipment.

Example 4 includes the system of any of Examples 1-3, wherein the wireless connection between the at least one mesh radio unit and the at least one donor radio unit is implemented using out-of-band channels, wherein the out-of-band channels are not used for wireless communications between the at least one donor radio unit and user equipment.

Example 5 includes the system of any of Examples 1-4, wherein the at least one baseband unit entity is configured to mark packets destined for the at least one mesh radio unit, wherein the at least one donor radio unit is configured to separate the packets destined for the at least one mesh radio unit from packets destined for user equipment in communication with the at least one donor radio unit based on the marking.

Example 6 includes the system of any of Examples 1-5, wherein the at least one mesh radio unit and the at least one donor radio unit are configured to transmit signals to user equipment using the same physical cell identifier.

Example 7 includes the system of any of Examples 1-6, wherein the at least one mesh radio unit is configured to transmit signals to user equipment using a first physical cell identifier, wherein the at least one donor radio unit is configured to transmit signals to user equipment using a second physical cell identifier different than the first physical cell identifier.

Example 8 includes the system of any of Examples 1-7, wherein the wireless connection is implemented using licensed spectrum, shared licensed spectrum, and/or unlicensed spectrum.

Example 9 includes the system of any of Examples 1-8, wherein the at least one baseband unit entity includes: one or more central units and one or more distributed units, wherein the at least one donor radio unit is communicatively coupled to the one or more distributed units via the wired connection; or
a baseband controller, wherein the at least one donor radio unit is communicatively coupled to the baseband controller via the wired connection.

Example 10 includes the system of any of Examples 1-9, wherein the plurality of radio units includes a plurality of donor radio units, wherein at least two donor radio units of the plurality of donor radio units are communicatively coupled to the at least one mesh radio unit and configured to communicate fronthaul communications with the at least one mesh radio unit using respective wireless connections.

Example 11 includes the system of any of Examples 1-10, wherein the plurality of radio units includes a plurality of donor radio units, wherein the plurality of radio units includes a first mesh radio unit and a second mesh radio unit, wherein the first mesh radio unit is communicatively coupled to a first subset of the plurality of donor radio units, wherein the second mesh radio unit is communicatively coupled to a second subset of the plurality of donor radio units different than the first subset of the plurality of donor radio units.

Example 12 includes the system of any of Examples 1-11, wherein the plurality of radio units includes a first mesh radio unit and a second mesh radio unit, wherein the second mesh radio unit is communicatively coupled to the at least one donor radio unit and the at least one baseband unit entity via the first mesh radio unit.

Example 13 includes the system of Example 12, wherein the first mesh radio unit and the at least one donor radio unit are configured to transmit signals to user equipment using a first physical cell identifier, wherein the second mesh radio unit is configured to transmit signals to user equipment using a second physical cell identifier different than the first physical cell identifier.

Example 14 includes a method of operation for a mesh radio unit, comprising: conducting a cell search procedure; establishing a wireless connection with at least one donor radio unit; obtaining network configuration details from a management system; receiving downlink fronthaul communications from the at least one donor radio unit via the wireless connection; and transmitting downlink communications to user equipment based on the downlink fronthaul communications.

Example 15 includes the method of Example 14, wherein conducting the cell search procedure includes acquiring time and frequency synchronization with a base station using synchronization signals.

Example 16 includes the method of any of Examples 14-15, wherein establishing the wireless connection with the at least one donor radio unit includes using an authentication procedure.

Example 17 includes the method of any of Examples 14-16, wherein transmitting downlink communications to user equipment based on the downlink fronthaul communications comprises transmitting the downlink communications using a first physical cell identifier, wherein the at least one donor radio unit transmits signals to user equipment using the first physical cell identifier.

Example 18 includes the method of any of Examples 14-17, wherein transmitting downlink communications to user equipment based on the downlink fronthaul communications comprises transmitting the downlink communications using a first physical cell identifier, wherein the at least one donor radio unit is configured to transmit signals to user equipment using a second physical cell identifier different than the first physical cell identifier.

Example 19 includes the method of any of Examples 14-18, wherein the at least one donor radio unit includes a plurality of donor radio units; wherein establishing the wireless connection with at least one donor radio unit comprises establishing respective wireless connections with each donor radio unit of the plurality of donor radio units; and wherein receiving downlink fronthaul communications from the at least one donor radio unit via the wireless connection comprises receiving downlink fronthaul communications from each respective donor radio unit via the respective wireless connections.

Example 20 includes the method of any of Examples 16-19, wherein establishing a wireless connection with the at least one donor radio unit includes establishing a wireless connection with the at least one donor radio unit via a second mesh radio unit, wherein the second mesh radio unit is communicatively coupled to a baseband unit entity via a second wireless connection with the at least one donor radio unit and a wired connection between the at least one donor radio unit and the baseband unit entity.

A number of embodiments of the invention defined by the following claims have been described. Nevertheless, it will be understood that various modifications to the described embodiments may be made without departing from the spirit and scope of the claimed invention. Accordingly, other embodiments are within the scope of the following claims.

What is claimed is:

1. A system, comprising:
at least one baseband unit entity;
a plurality of radio units including:
at least one donor radio unit communicatively coupled to the at least one baseband unit entity via a wired connection; and
at least one mesh radio unit communicatively coupled to the at least one donor radio unit via a wireless connection, wherein the at least one mesh radio unit is communicatively coupled to the at least one baseband unit entity via the at least one donor radio unit; and
a plurality of antennas communicatively coupled to the plurality of radio units, wherein each respective radio unit of the plurality of radio units is communicatively coupled to a respective subset of the plurality of antennas;
wherein the at least one baseband unit entity, the plurality of radio units, and the plurality of antennas are configured to implement a base station for wirelessly communicating with user equipment;
wherein the at least one donor radio unit is configured to communicate fronthaul communications with the at least one mesh radio unit over the wireless connection.

2. The system of claim 1, wherein the at least one mesh radio unit is configured to conduct a cell search procedure using in-band channels, wherein the in-band channels are also used for wireless communications between the at least one donor radio unit and user equipment.

3. The system of claim 1, wherein the wireless connection between the at least one mesh radio unit and the at least one donor radio unit is implemented using in-band channels, wherein the in-band channels are also used for wireless communications between the at least one donor radio unit and user equipment.

4. The system of claim 1, wherein the wireless connection between the at least one mesh radio unit and the at least one donor radio unit is implemented using out-of-band channels, wherein the out-of-band channels are not used for wireless communications between the at least one donor radio unit and user equipment.

5. The system of claim 1, wherein the at least one baseband unit entity is configured to mark packets destined for the at least one mesh radio unit, wherein the at least one donor radio unit is configured to separate the packets destined for the at least one mesh radio unit from packets destined for user equipment in communication with the at least one donor radio unit based on the marking.

6. The system of claim 1, wherein the at least one mesh radio unit and the at least one donor radio unit are configured to transmit signals to user equipment using the same physical cell identifier.

7. The system of claim 1, wherein the at least one mesh radio unit is configured to transmit signals to user equipment using a first physical cell identifier, wherein the at least one donor radio unit is configured to transmit signals to user equipment using a second physical cell identifier different than the first physical cell identifier.

8. The system of claim 1, wherein the wireless connection is implemented using licensed spectrum, shared licensed spectrum, and/or unlicensed spectrum.

9. The system of claim 1, wherein the at least one baseband unit entity includes:
one or more central units and one or more distributed units, wherein the at least one donor radio unit is communicatively coupled to the one or more distributed units via the wired connection; or
a baseband controller, wherein the at least one donor radio unit is communicatively coupled to the baseband controller via the wired connection.

10. The system of claim 1, wherein the plurality of radio units includes a plurality of donor radio units, wherein at least two donor radio units of the plurality of donor radio units are communicatively coupled to the at least one mesh radio unit and configured to communicate fronthaul communications with the at least one mesh radio unit using respective wireless connections.

11. The system of claim 1, wherein the plurality of radio units includes a plurality of donor radio units, wherein the plurality of radio units includes a first mesh radio unit and a second mesh radio unit, wherein the first mesh radio unit is communicatively coupled to a first subset of the plurality of donor radio units, wherein the second mesh radio unit is communicatively coupled to a second subset of the plurality of donor radio units different than the first subset of the plurality of donor radio units.

12. The system of claim 1, wherein the plurality of radio units includes a first mesh radio unit and a second mesh radio unit, wherein the second mesh radio unit is communicatively coupled to the at least one donor radio unit and the at least one baseband unit entity via the first mesh radio unit.

13. The system of claim 12, wherein the first mesh radio unit and the at least one donor radio unit are configured to transmit signals to user equipment using a first physical cell identifier, wherein the second mesh radio unit is configured to transmit signals to user equipment using a second physical cell identifier different than the first physical cell identifier.

14. A method of operation for a mesh radio unit, comprising:
conducting a cell search procedure;
establishing a wireless connection with at least one donor radio unit;
obtaining network configuration details from a management system;
receiving downlink fronthaul communications from the at least one donor radio unit via the wireless connection; and
transmitting downlink communications to user equipment based on the downlink fronthaul communications.

15. The method of claim 14, wherein conducting the cell search procedure includes acquiring time and frequency synchronization with a base station using synchronization signals.

16. The method of claim 14, wherein establishing the wireless connection with the at least one donor radio unit includes using an authentication procedure.

17. The method of claim 14, wherein transmitting downlink communications to user equipment based on the downlink fronthaul communications comprises transmitting the downlink communications using a first physical cell identifier, wherein the at least one donor radio unit transmits signals to user equipment using the first physical cell identifier.

18. The method of claim 14, wherein transmitting downlink communications to user equipment based on the downlink fronthaul communications comprises transmitting the downlink communications using a first physical cell identifier, wherein the at least one donor radio unit is configured to transmit signals to user equipment using a second physical cell identifier different than the first physical cell identifier.

19. The method of claim 14, wherein the at least one donor radio unit includes a plurality of donor radio units;
wherein establishing the wireless connection with at least one donor radio unit comprises establishing respective wireless connections with each donor radio unit of the plurality of donor radio units; and
wherein receiving downlink fronthaul communications from the at least one donor radio unit via the wireless connection comprises receiving downlink fronthaul communications from each respective donor radio unit via the respective wireless connections.

20. The method of claim 16, wherein establishing a wireless connection with the at least one donor radio unit includes establishing a wireless connection with the at least one donor radio unit via a second mesh radio unit, wherein the second mesh radio unit is communicatively coupled to a baseband unit entity via a second wireless connection with the at least one donor radio unit and a wired connection between the at least one donor radio unit and the baseband unit entity.
